(19) United States
(12) Patent Application Publication
(10) Pub. No.: US 2020/0245245 A1
(43) Pub. Date: Jul. 30, 2020

(54) INFORMATION PROCESSING DEVICE, WIRELESS TERMINAL, AND NON-TRANSITORY COMPUTER-READABLE MEDIUM

(71) Applicant: Oki Data Corporation, Tokyo (JP)

(72) Inventor: Tsutomu IWASAKI, Tokyo (JP)

(21) Appl. No.: 16/684,829

(22) Filed: Nov. 15, 2019

(30) Foreign Application Priority Data
Jan. 30, 2019 (JP) 2019-013921

(51) Int. Cl. H04W 52/02; H04W 88/08; G06F 3/12

(52) U.S. Cl. CPC H04W 52/0229; H04W 52/0206; G06F 3/1287; G06F 3/1231; G06F 3/1218; H04W 88/08

(57) ABSTRACT

An information processing device has a function of a wireless access point identified by a first identification name. The information processing device includes a wireless part that performs wireless communication as the wireless access point; an information processing part that performs processing of information according to a processing request obtained via the wireless part; and a control part that switches operation modes of the information processing device. In switching the operation modes to a power saving mode lower in power consumption than a normal mode in which the information processing part performs the information processing, the control part sets a power saving SSID to the wireless part. The control part switches the operation modes from the power saving mode when the wireless part detects a search for the power saving SSID.

### BACKGROUND OF THE INVENTION

### 1. Field of the Invention

The present invention relates to an information processing device, a wireless terminal, and a non-transitory computer-readable medium.

### 2. Description of the Related Art

In wireless communication, a wireless access point is conventionally used as a base station. A wireless access point waits for access from a client, and thus, usually, is always operating. Accordingly, the wireless access point is powered, and as a result power consumption becomes large.

Relating to this, in JP2015-505192A (Publication number of Japanese translation of PCT international application), Sasha et al. discloses a wireless access point having a power saving mode. The wireless access point disclosed in the Patent Reference 1 enters into the power saving mode when there is no active connection related to the wireless access point. In the power saving mode, the wireless access point stops transmission of a beacon. When a trigger signal is received, the wireless access point returns to a normal mode from the power saving mode.

### SUMMARY OF THE INVENTION

In the conventional technology, even if a wireless access point enters into the power saving mode, the wireless access point returns to the normal mode when a probe request as a trigger signal is received from a client. The client sends probe requests with a set period. Accordingly, even if the wireless access point is in the power saving mode, the wireless access point returns to the normal mode periodically. In particular, in the case where a plurality of clients access a wireless access point, it is difficult for the wireless access point even to enter into the power saving mode.

Thus, an object of one or a plurality of modes of the present invention is to achieve suppression of returning from a power saving mode in a device having a function of a wireless access point.

One mode of the present invention provides an information processing device having a function of a wireless access point identified by a first identification name. The information processing device has a wireless part that performs wireless communication as the wireless access point, the first identification name being set to the wireless part; an information processing part that performs information processing according to a processing request obtained via the wireless part; and a control part that switches operation modes of the information processing device. In switching the operation modes to a power saving mode lower in power consumption than a normal mode in which the information processing part performs the information processing, the control part sets, instead of the first identification name, a second identification name different from the first identification name to the wireless part. The control part switches the operation modes from the power saving mode when the wireless part detects a search for the second identification name.

Another mode of the present invention provides a wireless terminal that makes a request for processing information to an information processing device having a function of a wireless access point identified by a first identification name. The wireless terminal has a communication part that performs wireless communication with the information processing device by using the first identification name to connect to the information processing device; and a control part that searches for a second identification name different from the first identification name, when it becomes impossible to connect to the information processing device by using the first identification name, and thereafter searches for the first identification name again via the communication part.

Another mode of the present invention provides a non-transitory computer-readable medium storing a program that makes a computer function as a wireless terminal that makes a request for processing information to an information processing device having a function of a wireless access point identified by a first identification name. The program makes the computer function as a communication part that performs wireless communication with the information processing device by using the first identification name to connect to the information processing device; and a control part that searches for a second identification name different front the first identification name, when it becomes impossible to connect to the information processing device by using the first identification name, and thereafter searches for the first identification name again via the communication part.

According to one or a plurality of modes of the present invention, it is possible to suppress returning from a power saving mode in a device having a function as a wireless access point.

### BRIEF DESCRIPTION OF THE DRAWINGS

FIG. 1 is a block diagram representing schematically a configuration of an information processing system according to an embodiment of the present invention;

FIG. 2 is a block diagram representing schematically a configuration of an information processing device in the embodiment;

FIGS. 3(A) and 3(B) are block diagrams representing examples of hardware configuration;

FIG. 4 is a block diagram representing schematically a configuration of a wireless terminal in the embodiment;

FIG. 5 is a schematic diagram indicating an example of registration information;

FIGS. 6(A)-6(F) are schematic diagrams indicating transition of screen image displayed on an operation part;

FIG. 7 is a sequence diagram indicating operation performed by the information processing device and the wireless terminal;

FIG. 8 is a flowchart indicating operation of the information processing device; and

FIG. 9 is a flowchart indicating operation of the wireless terminal.

### DETAILED DESCRIPTION OF THE INVENTION

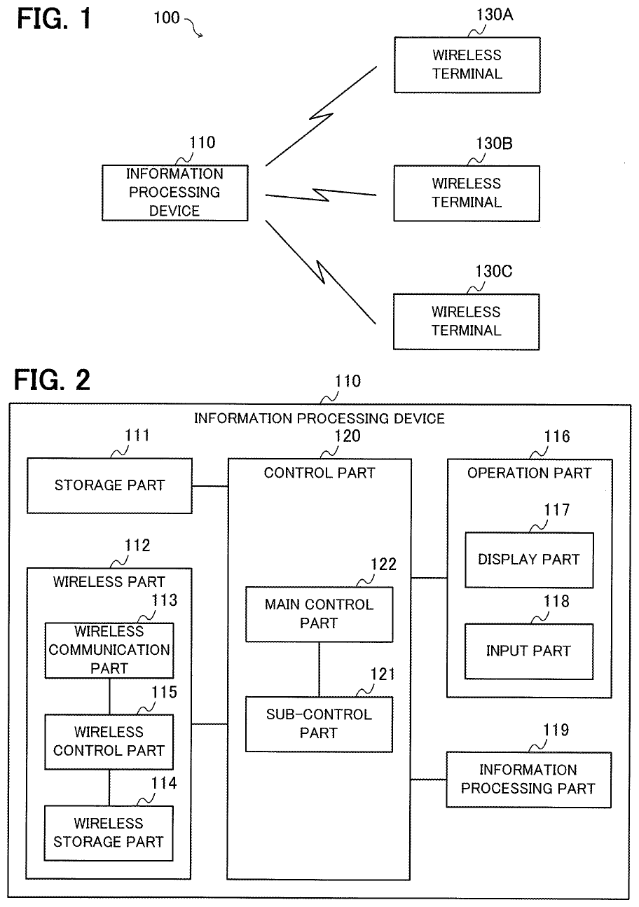

FIG. 1 is a block diagram representing schematically a configuration of an information processing system 100 according to an embodiment of the present invention.

The information processing system 100 includes an information processing device 110, and wireless terminals 130A, 130B, and 130C.

In the information processing system 100, the information processing device 110 has a function of a wireless access point, and each of the wireless terminals 130A, 130B, and 130C connects wirelessly as a client to the information processing device 110, and then requests the Information processing device 100 to process information.

Here, the wireless terminals 130A, 130B, and 130C are configured similarly to one another as for the function of connecting wirelessly, as clients, to the information processing device 110. Thus, when it is not necessary to differentiate each of the wireless terminals 130A, 130B, and 130C, each of the wireless terminals 130A, 130B, and 130C is referred to as a wireless terminal 130. The wireless terminals 130A, 130B, and 130C can be different from one another in configuration, except for the function of connecting wirelessly, as clients, to the information processing device 110. Among the wireless terminals 130A, 130B, and 130C, a personal computer or a tablet may be included, for example.

FIG. 2 is a block diagram representing schematically a configuration of the information processing device 110.

The information processing device 110 includes a storage part 111, a wireless part 112, an operation part 116, an information processing part 119, and a control part 120.

As operation modes, the information processing device 110 has at least a normal mode and a power saving mode.

The storage part 111 stores information, programs, and the like required for processing in the information processing device 110. For example, the storage part 111 stores configuration information of the information processing device 110.

A predetermined Service Set Identifier (SSID) is set to the wireless part 112, so that the wireless part 112 performs wireless communication as a wireless access point identified by the SSID. Here, SSID used for the wireless part 112 to perform wireless communication when the information processing device 110 is in the normal mode is also referred to as normal SSID (first SSID). An SSID is an identification name for identifying an access point.

The wireless part 112 includes a wireless communication part 113, a wireless storage part 114, and a wireless control part 115.

The wireless communication part 113 is a wireless communication interface for per forming wireless communication. The wireless communication part 113 includes an antenna, which is synchronized with a frequency of 2.4 GHz or 5 GHz used in Wi-Fi communication; a transmitting part having transistors or FETs, which supplies the antenna with power based on an electrical signal from the wireless control part 115, to transmit electrical waves; and a receiving part, which demodulates electrical waves received by the antenna into an electrical signal.

The wireless storage part 114 stores information required for processing in the wireless part 112.

For example, the wireless storage part 114 stores an SSID. In detail, when the information processing device 110 is in the normal mode, the wireless storage part 114 stores the normal SSID. On the other hand, when the information processing device 110 is in the power saving mode, the wireless storage part 114 stores a power saving SSID different from the normal SSID. Power saving SSID is an SSID used as a return factor for a condition that the information processing device 110 returns from the power saving mode. Power saving SSID is also referred to as second SSID. In the present embodiment, the power saving SSID is used only in a search performed for returning the information processing device 110 from the power saving mode.

The wireless control part 115 controls processing in the wireless part 112.

For example, the wireless control part 115 controls processing required for the wireless part 112 to function as a wireless access point. In detail, when the information processing device 110 is in the normal mode, the wireless control part 115 performs wireless communication via the wireless communication part 113 by using the SSID (normal SSID) stored in the wireless storage part 114.

Further, when the information processing device 110 is in the power saving mode, the wireless control part 115 determines whether communication from a wireless terminal 130 satisfies the return factor or not. In the present embodiment, the return factor is that a wireless terminal 130 performs a search for the power saving SSID. Here, a search is executed, for example, by a wireless terminal 130 sending a probe request to the information processing device 110. In other words, the return factor is satisfied when a wireless terminal 130 requests the information processing device 110 to confirm the power saving SSID.

Then, when the return factor is satisfied in the power saving mode, the wireless control part 115 sends a notification to the control part 120. Here, the notification indicates, for example, that the return factor has been satisfied.

The operation part 116 displays a screen image and receives input of operation.

The operation part 126 includes a display part 117 and an input part 113.

The display part 117 displays a screen image.

The input part 118 receives input of operation.

The information processing part 119 performs processing of information in the information processing device 110. For example, the information processing part 119 performs processing of information according to a processing request obtained via the wireless part 112.

In the present embodiment, the information processing part 119 functions as an image processing part that processes an image. In this case, the information processing device 110 functions as an image processing device.

Also, the information processing part 119 may function as an image forming part that forms an image on a medium. In this case, the information processing device 110 functions as an image forming device.

The control part 120 controls processing in the information processing device 110. For example, the control part 120 switches between operation modes of the information processing device 110.

In detail, the control part 120 sets the power saving SSID in place of the normal SSID to the wireless part 112 when the operation mode is switched to the power saving mode, and switches the operation mode from the power saving mode when the wireless part 112 detects a search for the power saving SSID.

The power saving mode is an operation mode that is lower in power consumption than the normal mode. For example, in the power saving mode, the control part 120 stops functioning of the storage part 111 and the information processing part 119, and stops power supply to the storage part 111 and the information processing part 119. In the power saving mode, the control part 120 may also stop functioning of the operation part 116, and stop power supply to the operation part 116. Further, in the power saving mode, the control part 120 may stop or lower some functions of the operation part 116 so as to lower the power consumed by the operation part 116. For example, the power consumption of the display part 117 can be lowered by lowering the brightness of displaying on the display part 117.

Although the wireless part 112 functions even in the power saving mode, wireless communication using the normal SSID is restrained. Accordingly, even if a search for the normal SSID is detected, the wireless part 112 does not respond to the search. Further, in the power saving mode, the wireless part 112 does not even transmit a beacon.

The normal mode is a mode in which the information processing part 119 performs processing of information.

In the normal mode, the control part 120 makes the storage part 111 and the information processing part 119 function to perform processing in the information processing device 110. It is assumed that, if the functions of the operation part 116 is stopped or lowered in the power saving mode, all the functions of the operation part 116 become available as usual in the normal mode.

The control part 120 includes a sub-control part 121 and a main control part 122.

In the power saving mode, only the sub-control part 121 functions, and the functions of the main control part 122 are stopped. Accordingly, also in the control part 120 itself, power consumption is lowered.

It is assumed that, in the normal mode, the sub-control part 121 and the main control part 122 are functioning.

The sub-control part 121 controls the processing in the information processing device 110 in the power saving mode. For example, the sub-control part 121 functions as an activation processing part that activates the main control part 122 when a notification is received from the wireless control part 115 in the power saving mode.

The main control part 122 is activated according to an instruction from the sub-control part 121. In the course of or after the activation, the main control part 122 activates the storage part 111 and the information processing part 119 also. Further, in the course of or after the activation, the main control part 122 makes all the functions of the operation part 116 available as usual, if the functions of the operation part 116 is stopped or lowered in the power saving mode.

The main control part 122 controls the processing in the information processing device 110 in the normal mode. For example, the main control part 122 obtains a processing request from a wireless terminal 130 via the wireless part 112, and makes the information processing part 119 perform processing according to the obtained processing request. In detail, when an image forming request (print request) that includes image information indicating an image is received as a processing request via the wireless part 112, the main control part 122 makes the information processing part 119 form an image on a medium according to the image information. Further, when an image information obtaining request is received as a processing request from a wireless terminal 130 via the wireless part 112, the main control part 122 sends image information indicating an image formed by scanning a document in the information processing part 129 to the request source via the wireless part 112.

Further, in the case where a processing request requesting predetermined processing has not been received for a predetermined period via the wireless part 112, the main control part 122 sets the return factor in the wireless part 112, and switches the operation mode of the information processing device 110 to the power saving mode.

For example, the predetermined processing may be processing in the application layer in the Transmission Control Protocol/Internet Protocol (TCP/IP) reference model, or processing concerning an image, or processing performed by the information processing part 119. Further, the predetermined processing may be a processing that is performed not in the wireless part 112 but in the control part 120 or the information processing part 119.

Further, the main control part sets the return factor in the wireless part 112 by storing the power saving SSID in the wireless storage part 114.

In the present embodiment, it is assumed that the power saving SSID is generated from the normal SSID according to a predetermined rule. For example, the power saving SSID is generated by adding a specific character string such as “power-save” to the end of the normal SSID.

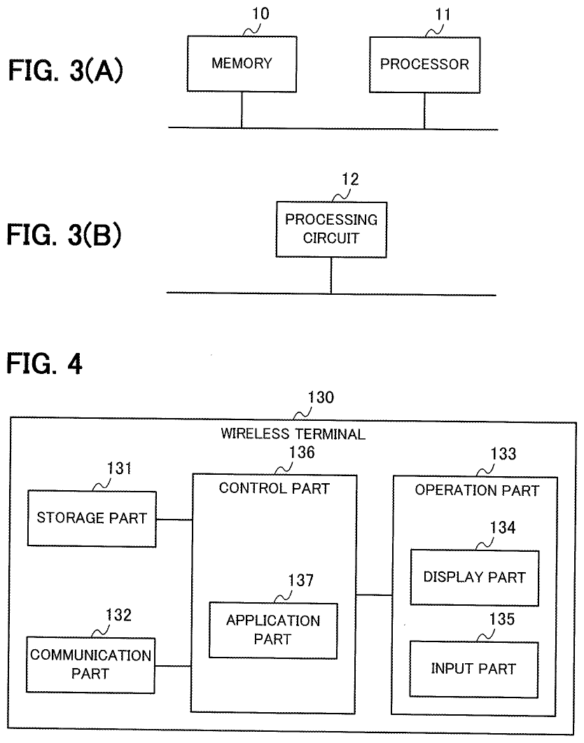

As shown in FIG. 3(A), a part or all of the wireless control part 115 and the control part 120 described above can be implemented, for example, by a memory 10 and a processor 11 such as a Central Processing Unit (CPU) for executing a program stored in the memory 10. Such a program may be provided through a network, or may be provided being stored in a storage medium (a non-transitory computer-readable medium). That is to say, such a program may be provided as a program product, for example. In other words, the information processing device 110 can be implemented also by a computer.

Further, as shown in FIG. 3(B), a part or all of the wireless control part 115 and the control part 120 can be implemented, for example, by a processing circuit 12 such as a single circuit, a composite circuit, a programmed processor, an Application Specific Integrated Circuit (ASIC), or a Field Programmable Gate Array (FPGA).

The storage part 111 and the wireless storage part 114 can be implemented by a nonvolatile memory.

The operation part 116 can be implemented by a touch panel, for example.

A part or all of the information processing part 119 can be included in the control part 120.

FIG. 4 is a block diagram representing schematically a configuration of a wireless terminal 130.

The wireless terminal 130 includes a storage part 131, a communication part 132, an operation part 133, and a control part 136.

The storage part 131 stores information required for processing in the wireless terminal 130.

For example, the storage part 131 stores registration information in which connection information needed to connect to the information processing device 110 to which the wireless terminal 130 can request processing is registered.

The connection information includes a device name, which is device identification information for identifying the information processing device 110; an address for accessing the Information processing device 110; the normal SSID of the information processing device 110; and an authentication information required for connecting to the information processing device 110. The authentication information is, for example, a security name as security identification information for identifying the security (encryption scheme) used by the information processing device 110 and a password (encryption key) in the security used by the information processing device 110.

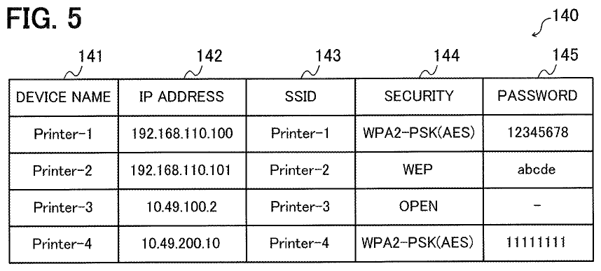

For example, in the case where the information processing device 110 is a printer as an information processing device or an image forming device, the below-described application part 137 connects to the information processing device 110 and makes the information processing device 110 execute printing, and, as a result, a registration table 140 as shown in FIG. 5 is stored as the registration information in the storage part 131.

The registration table 140 has a device name column 141, an IP address column 142, an SSID column 143, a security column 144, and a password column 145, and each raw stores connection information for connecting to one information processing device 110.

The device name column 141 stores the device name of an information processing device 110.

The IP address column 142 stores the IP address of the information processing device 110.

The SSID column 143 stores the SSID of the information processing device 110. The SSID stored here is the normal SSID of the information processing device 110.

The security column 144 stores the security name of the security used by the information processing device 110.

The password column 145 stores the password of the security used by the information processing device 110.

To return to FIG. 4, the communication part 132 is a wireless communication interface that performs communication wirelessly. In the present embodiment, the communication part 132 performs wireless communication with the information processing device 110 by using the normal SSID.

The operation part 133 displays a screen image and receives input of operation.

The operation part 133 includes a display part 134 and an input part 135.

The display part 134 displays a screen image.

The input part 135 receives input of operation.

The control part 136 controls processing in the wireless terminal 130. For example, the control part 136 includes an application part 137.

According to user's operation inputted via the operation part 133, the application part 137 requests the information processing device 110 to execute processing.

Here, when the communication part 132 becomes unable to connect to the information processing device 110 by using the normal SSID, the application part 137 searches for the power saving SSID via the communication part 132, and thereafter searches for the normal SSID again.

A part or all of the control part 136 described above can be implemented, for example, by a memory 10 and a processor 11, as shown in FIG. 3(A). A program that a processor 11 executes may be provided through a network, or may be provided being stored in a storage medium (a non-transitory computer-readable medium). That is to say, such a program may be provided as a program product, for example. In other words, the wireless terminal 130 can be implemented also by a computer.

Further, a part or all of the control part 136 can be implemented also by a processing circuit 12, for example, as shown in FIG. 3(B).

The storage part 131 can be implemented by a nonvolatile memory.

The operation part 133 can be implemented by a touch panel, for example.

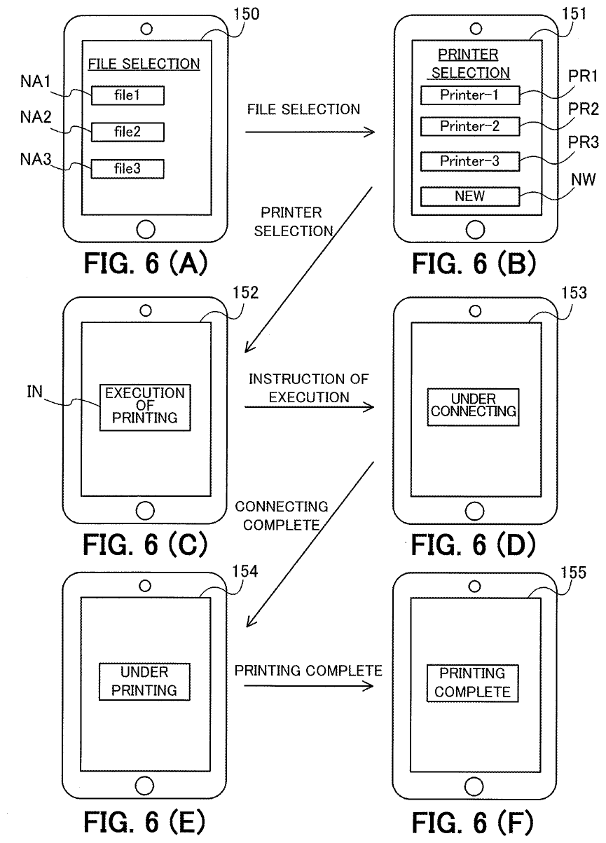

FIGS. 6(A)-6(F) are schematic diagrams representing transition of screen images displayed on the operation part 133 when the application part 137 receives input of an instruction from a user and makes the information processing device 110 execute printing, in the case where the information processing device 110 is a printer as an image processing device or an image forming device.

First, when a user selects a predetermined application installed in a wireless terminal 130, the application part 137 is activated and makes the display part 134 display a file selection screen image 150 shown in FIG. 6(A). File names NA1-NA3 of files that can be printed by the information processing device 110 are displayed in the file selection screen image 150.

When at least one of the file names NA1-NA3 is selected in the file selection screen image 150, the application part 137 makes the display part 134 display a request destination selection screen image 151 shown in FIG. 6(B). Printer names PR1-PR3 as device names for identifying an information processing device 110 to which a request for processing (printing) is made and a search field NW for searching for a new destination of connection (request destination) are displayed in the request destination selection screen image 151.

When any of the printer names PR1-PR3 is selected in the request destination selection screen image 151, the application part 137 makes the display part 134 display an execution instruction input screen image 152 shown in FIG. 6(C). An instruction input field IN for inputting an instruction of making a request to the selected printer for processing (printing) is displayed in the execution instruction input screen image 152.

When an instruction input field IN is pushed or, in other words, an execution instruction is inputted in the execution instruction input screen image 152, the application part 137 makes the display part 134 display the “under connecting” screen image 153 shown in FIG. 6(D). Here, the application part 137 connects to the information processing device 110 corresponding to the selected printer.

When connection to the information processing device 110 corresponding to the selected printer is successful, the application part 137 sends the file selected in the file selection screen image 150 shown in FIG. 6(A) to the connected information processing device 110 via the communication part 132. At this time, the application part 137 makes the display part 134 display the “under printing” screen image 154 shown in FIG. 6(E).

Then, when a notification of completion of printing is received from the information processing device 110 corresponding to the selected printer, the application part 137 makes the display part 134 display the “printing complete” screen image 155 shown in FIG. 6(F).

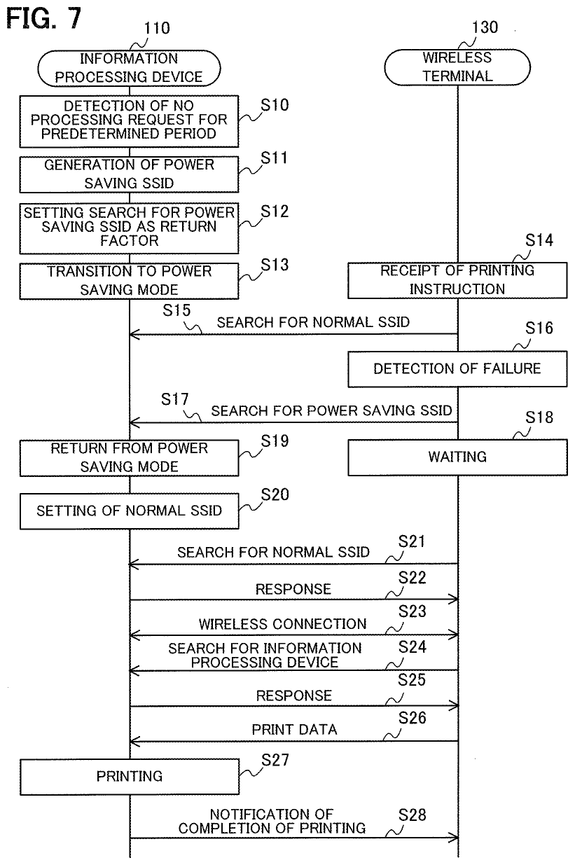

FIG. 7 is a sequence diagram indicating operation performed by the information processing device 110 and a wireless terminal 130.

The sequence diagram shown in FIG. 7 will be explained assuming that the information processing device 110 is a printer.

First, the main control part 122 of the information processing device 110 detects that a processing request requesting the predetermined processing is not received for the predetermined period from a wireless terminal 130 (S10).

To switch the information processing device 110 to the power saving mode, the main control part 122 generates the power saving SSID according to the predetermined rule from the SSID that is used by the wireless part 112 to function as a wireless access point (S11).

The stain control part 122 makes the wireless storage part 114 store the power saving SSID in order to set a search for the power saving SSID as the return factor (S12). As a result of this, the wireless control part 115 stops using the normal SSID and transmitting the beacon.

The main control part 122 switches the information processing device 110 to the power saving mode, and stops its own operation (S13).

On the other hand, in a wireless terminal 130, the operation part 133 receives input of an instruction of printing accompanied by a selection of information processing device 110 from a user (S14).

In this case, the application part 137 refers to the registration table 140 shown in FIG. 5, to search for the SSID of the information processing device 110 (S15). In detail, the application part 137 makes the search by sending search packets as a probe request via the communication part 132.

However, since the power saving SSID was set in the step S12, the information processing device 110 does not make a probe response to the probe request from the wireless terminal 130. Accordingly, the application part 137 of the wireless terminal 130 determines that connection to the information processing device 110 has failed (S16).

When connection using the normal SSID of the information processing device 110 fails, the application part 137 generates the power saving SSID from the normal SSID according to the predetermined rule, and searches for the power saving SSID (S17).

Then, the application part 137 waits for a predetermined period (S18).

When the wireless control part 115 of the information processing device 110 receives the probe request using the power saving SSID via the wireless communication part 113, the wireless control part 115 determines that the return factor is satisfied by the occurrence of the search for the power saving SSID. When the return factor is satisfied, the wireless control part 115 sends a notification to the sub-control part 121, and the sub-control part 121 activates the main control part 122. When activated, the main control part 122 switches the information processing device 110 from the power saving mode to the normal mode (S19).

Then, the main control part 122 sets the normal SSID in the wireless part 112 by storing the normal SSID in the wireless storage part 114 (S20).

In the wireless terminal 130, after the waiting of the predetermined period, the application part 137 searches again for the normal SSID of the information processing device 110 (S21).

In this case, since not the power saving SSID but the normal SSID is set in the wireless part 112 of the information processing device 110, the wireless control part 115 makes a response (S22). In detail, the wireless control part 115 makes a response by sending response packets as a probe response.

Then, the wireless terminal 130 and the information processing device 110 establish wireless connection according to the known procedures (S23).

Then, when connection between the wireless terminal 130 and the information processing device 110 is established, the application part 137 of the wireless terminal 130 refers to the registration table shown in FIG. 5, to make a search for the information processing device 110 by using the IF address (S24).

When a response to the search for the IP address is received from the information processing device 110 (S25), the application part 137 sends print data as a processing request including image information to the information processing device 110 via the communication part 132 (S26).

In the information processing device 110, the main control part 122 receives the print data via the wireless part 112 and gives the print data to the information processing part 119 to make the information processing part 119 execute printing (S27).

When printing is finished, the main control part 122 notifies the finish of printing to the wireless terminal 130 via the wireless part 112 (S28).

As described above, by switching from the normal SSID to the power saving SSID at the time of transition to the power saving mode, it becomes needless for the information processing device 110 to respond to a search for the normal SSID from another device. Accordingly, it becomes needless for the information processing device 110 to return to the normal mode every time a search is received. Further, since a search for the power saving SSID is performed only when the predetermined processing is to be performed, the information processing device 110 can enjoy the power saving effects of the power saving mode for a longer time. Further, since the power saving SSID is used only for returning to the normal mode, it is not necessary to send a beacon, and the information processing device 110 can reduce power consumption.

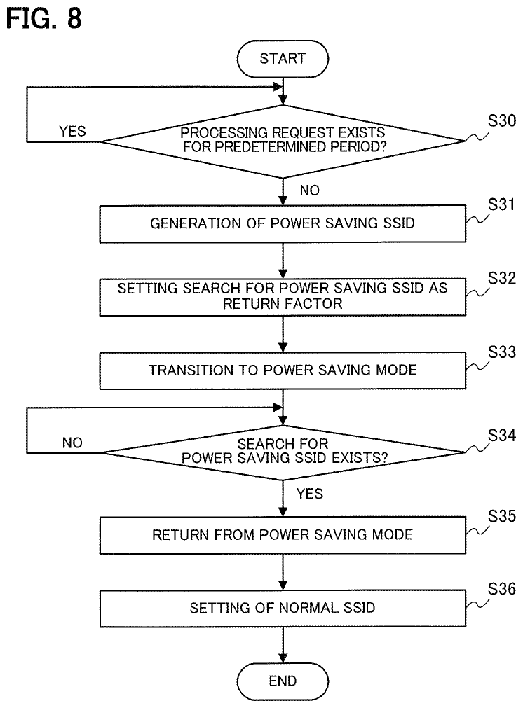

FIG. 8 is a flowchart indicating operation of the information processing device 110.

The flowchart shown in FIG. 8 explains operation in the period between transition to and returning from the power saving mode in a state that the information processing device 110 acts as a wireless access point.

First, the main control part 122 determines whether a processing request for the predetermined processing has been received from a wireless terminal 130 in the predetermined period (S30). In the case where such a processing request has not been received (No in S30), the processing proceeds to the step S31.

In the step S31, the main control part 122 generates the power saving SSID from the SSID of the wireless access point according to the predetermined rule, in preparation for transition to the power saving mode.

Then, the main control part 122 makes the wireless storage part 114 store the power saving SSID, so that a search for the power saving SSID is set as the factor (return factor) for switching the operation modes of the information processing device 110 from the power saving mode to the normal mode (S32).

Next, the main control part 122 makes the information processing device 110 make a transition to the power saving mode (S33).

In the power saving mode, the wireless control part 115 does not make the wireless communication part 113 transmit a beacon, and waits for a search for the power saving SSID (S34). When a search for the power saving SSID occurs (Yes in S34), the processing proceeds to the step S35.

In the step S35, the wireless control part 115 notifies the sub-control part 121, the sub-control part 121 activates the main control part 122, and the main control part 122 switches the operation mode of the information processing device 110 from the power saving mode to the normal mode.

Then, the main control part 122 makes the wireless storage part 114 store the normal SSID, to set the normal SSID in the wireless part 112 (S36). As a result, the wireless control part 115 functions as a wireless access point and restarts transmission of the beacon and response to a search for the normal SSID.

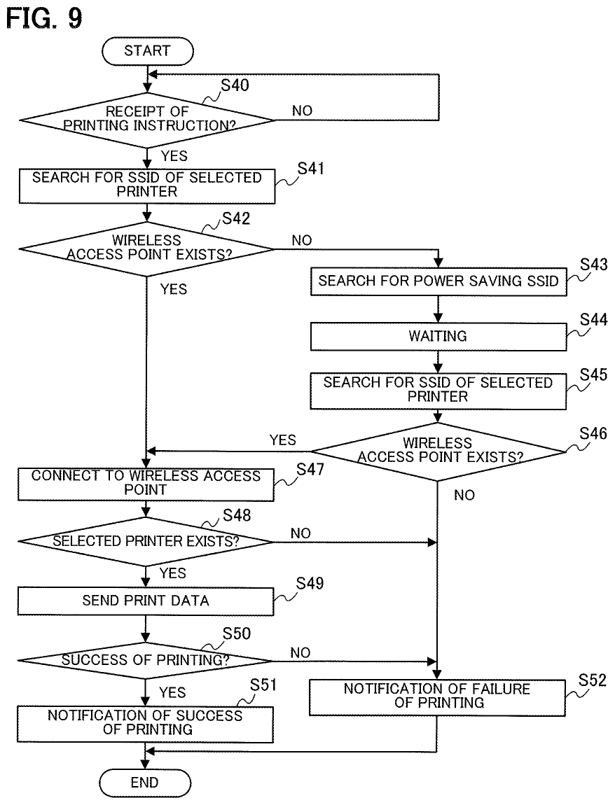

FIG. 9 is a flowchart indicating operation of a wireless terminal 130.

Here, description will be given assuming that the information processing device 110 is a printer.

Further, as for the wireless terminal 130, it is assumed that, when a user activates an application installed in the wireless terminal 130 by using the operation part 133, the application part 137 is set up in the control part 136.

The application part 137 determines whether the user has made an instruction of printing accompanied by a selection of information processing device 110 by using the operation part 133 (S40). In the case where such a printing instruction has been made (Yes in S40), the processing proceeds to the step S41.

In the step S41, the application part 137 searches for the SSID of the selected information processing device 110 by referring to the registration information stored in the storage part 131.

Then, the application part 137 determines whether the wireless access point exists or not based on reception of a response to the search in the step S41 (S42). In the case where the wireless access point exists (Yes in the step S42), the processing proceeds to the step S47. On the other hand, in the case where the wireless access point does not exist (No in the step S42), the processing proceeds to the step S43.

In the step S43, the application part 137 generates the power saving SSID from the SSID of the selected information processing device 110, and makes a search using the generated power saving SSID.

Then, the application part 137 waits for the predetermined period (S44).

After waiting, the application part 137 searches again for the SSID of the selected information processing device 110 (S45).

Then, the application part 137 determines whether the wireless access point exists or not based on reception of a response to the search in the step S45 (S46). In the case where the wireless access point exists (Yes in the step S46), the processing proceeds to the step S47. On the other hand, in the case where the wireless access point does not exist (No in the step S46), the processing proceeds to the step S52.

In the step S47, the application part 137 refers to the registration information stored in the storage part 131 and tries to establish connection to the IP address of the selected information processing device 110.

Then, the application part 137 determines whether the selected information processing device 110 exists or not based on whether such connection has been able to be established or not (S48). In the case where the selected information processing device 110 exists (Yes in S48), the processing proceeds to the step S49. On the other hand, in the case where the selected information processing device 110 does not exist (No in S48), the processing proceeds to the step S52.

In the step S49, the application part 137 sends the print data, of which the instruction of printing has been received from the user, to the information processing device 110 via the communication part 132.

Then, the application part 137 determines whether the printing has succeeded based on whether a notification of completion of printing has been received from the information processing device 110 (S50). In the case where the printing has succeeded (Yes in S50), the processing proceeds to the step S51. On the other hand, in the case where the printing has ended in failure (No in S50), the processing proceeds to the step S52.

In the step S51, the application part 137 makes the operation part 133 display the “printing complete” screen image 155 shown in FIG. 6, so as to notify the success in the printing to the user.

On the other hand, in the step S52, the application part 137 makes the operation part 133 display a printing failure screen image (not shown), so as to notify the failure in the printing to the user.

As described hereinabove, according to the embodiment, the information processing device 110 can suppress unnecessary returning to the normal mode by switching the SSID of the wireless access point to the power saving SSID at the time of transition to the power saving mode.

Further, the rule of converting the SSID of the wireless access point to the power saving SSID is held in common with the wireless terminals 130. Accordingly, when a user needs to access the information processing device 110, it is possible to make the information processing device 110 return to the normal mode to execute processing of a processing request from the user.

The information processing device 110 may be a printer as an image forming device, or an MFP, a copy machine, or a facsimile transceiver as an image processing device.

In the above-described embodiment, the power saving SSID is generated from the SSID, or in other words the normal SSID, of the wireless access point according to the predetermined rule. However, the embodiment is not limited to this example. For example, the Information processing device 110 may store a predetermined power saving SSID in the storage part 111. In that case, in a wireless terminal 130, for example the application part 137 may store the power saving SSID in the storage part 131, or a user may give the power saving SSID to the application part 137 by inputting the power saving SSID by using the operation part 133.

In the above-described embodiment, the operation modes of the information processing device 110 are the normal mode and the power saving mode. However, the operation modes may include another mode than the normal mode and the power saving mode.

### DESCRIPTION OF REFERENCE CHARACTERS

100: information processing system; 110: information processing device; 111: storage part; 112: wireless part; 113: wireless communication part; 114: wireless storage part; 115: wireless control part; 116: operation part; 117: display part; 118: input part; 119: information processing part; 120: control part; 121: sub-control part; 122: main control part; 130: wireless terminal; 131: storage part; 132: communication part; 133: operation part; 134: display part; 135: input part; 136: control part; and 137: application part.

What is claimed is:

1. An information processing device having a function of a wireless access point identified by a first identification name, comprising:
a wireless part that performs wireless communication as the wireless access point, the first identification name being set to the wireless part;
an information processing part that performs information processing according to a processing request obtained via the wireless part; and
a control part that switches operation modes of the information processing device; wherein
in switching the operation modes to a power saving mode lower in power consumption than a normal mode in which the information processing part performs the information processing, the control part sets, instead of the first identification name, a second identification name different from the first identification name to the wireless part; and
the control part switches the operation modes from the power saving mode when the wireless part detects a search for the second identification name.

2. An information processing device of claim 1, wherein:
the wireless part restrains wireless communication using the first identification name in the power saving mode.

3. An information processing device of claim 1, wherein:
the wireless part does not transmit a beacon in the power saving mode.

4. An information processing device of claim 1, wherein:
when a processing request requesting predetermined processing has not been received for a predetermined period via the wireless part in the normal mode, the control part switches the operation modes from the normal mode to the power saving mode.

5. An information processing device of claim 4, wherein:
the predetermined processing is processing in the application layer in the Transmission Control Protocol/Internet Protocol (TCP/IP) reference model.

6. An information processing device of claim 4, wherein:
the predetermined processing is processing concerning an image.

7. An information processing device of claim 4, wherein:
the predetermined processing is processing performed by the information processing part.

8. An information processing device of claim 4, wherein:
the predetermined processing is performed not in the wireless part but in the control part or the information processing part.

9. An information processing device of claim 1, wherein:
the second identification name is generated from the first identification name according to a predetermined rule.

10. An information processing device of claim 1, wherein:
the information processing part is an image processing part that processes an image.

11. An information processing device of claim 1, wherein:
the information processing part is an image forming part that forms an image on a medium.

12. A wireless terminal that makes a request for processing information to an information processing device having a function of a wireless access point identified by a first identification name, comprising:
a communication part that performs wireless communication with the information processing device by using the first identification name to connect to the information processing device; and
a control part that searches for a second identification name different from the first identification name, when it becomes impossible to connect to the information processing device by using the first identification name, and thereafter searches for the first identification name again via the communication part.

13. A non-transitory computer-readable medium storing a program that makes a computer function as a wireless terminal that makes a request for processing information to an information processing device having a function of a wireless access point identified by a first identification name, wherein:
the program makes the computer function as:
a communication part that performs wireless communication with the information processing device by using the first identification name to connect to the information processing device; and
a control part that searches for a second identification name different from the first identification name, when it becomes impossible to connect to the information processing device by using the first identification name, and thereafter searches for the first identification name again via the communication part.
